(19) United States
(12) Patent Application Publication
(10) Pub. No.: US 2002/0134257 A1
(43) Pub. Date: Sep. 26, 2002

(54) Forming ink images on convex surfaces

(75) Inventor: Stanley W. Stephenson, Spencerport, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/815,671

(22) Filed: Mar. 23, 2001

(51) Int. Cl. B41F 17/00

(52) U.S. Cl. 101/35

(57) ABSTRACT

Apparatus for printing images on a convex surface of an object includes an ink jet print head having a supply of ink and located in a printing position relative to the object, the ink jet print head including means for ejecting ink along a first axis which intersects the center of the convex surface at the printing position and holds the object. The apparatus rotates the object about a second and third axes which intersect at the center the convex surface during printing, and controls rotation and the ink jet print head to cause the ink jet print head to eject ink along the first axis onto different positions of the convex surface to form an image on the object.

### FIELD OF THE INVENTION

The present invention relates to printing ink jet images on convex surfaces.

### BACKGROUND OF THE INVENTION

There are numerous applications where it is desirable to print images onto objects. It is difficult to print such images on objects without distorting the image on the convex surface of the object.

Apparatus using ink jet heads to write on curved surfaces are shown in U.S. Pat. No. 5,289,767 and 5,433,146. U.S. Pat. No. 5,289,767 discloses method and apparatus for writing indicia on a wire. U.S. Pat. No. 5,433,146 discloses method and apparatus which prints indicia on pellet shaped articles (pills) using an ink jet head. Both patents write onto curve surfaces by translation of objects with convex surfaces and are not adapted to create images on convex objects. U.S. Pat. No. 5,142,976 describes apparatus for writing on poultry eggs. The printing unit uses a tampo print system to write onto eggs. The convex eggs are not rotated relative to the printing apparatus; a compliant surface conforms to the egg's surface when ink is deposited.

As shown in Japanese Patent JP 5-293955 A, an image is printed on a shoe. The disclosed arrangement uses a robot controlled arm with many rotating axes that are also translated to move a shoe past a fixed ink jet print head. Because the axes are translating as well as rotating, complex algorithms must be used to derive the control parameters for the drive motors to orient the printing surface to the ink jet print head. The arrangement is complex and requires complex controls.

U.S. Pat. No. 4,843,958 discloses apparatus for printing on eggs. Eggs are aligned, and held to permit rotation about a longitudinal axis. A fixed ink jet head writes a strip of image onto the egg surface as the egg is rotated. In column 10, lines 48-52 an image comprising multiple adjacent strips is formed by translating the eggs along the longitudinal axis by power operated means 166, shown in FIG. 13. The height of the image is severely limited in this design because the ink receiving surface moves away and tilts as the convex surface is translated along the longitudinal axis.

It would be useful to have simple apparatus for printing on convex objects. Sport balls such as golf balls, baseballs, and basketballs can have more value to an owner if they carry a famous signature or a picture. It would be useful to provide images on other convex objects such as Christmas tree ornaments and Easter eggs. It would be beneficial to load a blank convex object into a printer, and apply an image onto the ornament or sports ball.

Current ink jet printers are designed for printing on flat, not curved surfaces and cannot print on convex surfaces. Low-cost consumer ink jet printers, such as the Canon BJC-80, print on flat sheets or webs of materials. The sheet is sequentially advanced linearly under a print head, and the print head reciprocally translates on an axis perpendicular to the motion of the sheet as ink is ejected to form an image. Electronic signals control the motion of the sheet, the translation of the head and the operation of the print head to eject ink onto the due-receiving sheet. It would be useful to adapt the two motor drive of a consumer ink jet printer that writes on sheets to write onto convex objects.

Recently computer programs have been created which permit generation of convex panorama images. A system from IPIX (Interactive Pictures Corporation, Oak Ridge, Tenn.) uses a photographic camera to capture two complementary 180 degree views. An IPIX computer program combines digital data from the two 180 degree views into a file representing a full 360 degree panorama. Computer programs under operator guidance display a portion of the 360 degree image on a computer monitor. Portions of such images can be selectively viewed on a display. It would be useful to provide inexpensive means to display those 360 degree convex images on a convex object.

### SUMMARY OF THE INVENTION

It is therefore an object of the present invention to provide apparatus that forms images on convex surfaces of objects.

This object is achieved in apparatus for printing images on a convex surface of an object comprising:

a) an ink jet print head having a supply of ink and located in a printing position relative to the object, the ink jet print head including means for ejecting ink along a first axis which intersects the center of the convex surface at the printing position;

b) means for holding the object;

c) means coupled to holding means for rotating the object about second and third axes which intersect at the center the convex surface during printing; and

d) means for controlling rotation of the coupling means and the ink jet print head to cause the ink jet print head to eject ink along the first axis onto different positions of the convex surface to form an image on the object.

It is an advantage of the present invention to provide a printer that creates a print of an image on a convex surface of an object using an ink jet print head.

Apparatus is disclosed using two axes of rotation that continuously orients a convex surface to an ink jet head with up to 360 degrees of rotation. The use of two axes that intersect the center of the convex surface during printing facilitates the use of a simple structure that permits high quality images to be printed on a convex surface. The present invention is particularly suitable for printing on golf balls, baseballs, softballs, and basketballs used in athletic events and which are generally spherical. It is also highly effective for use in printing on convex type objects such as Christmas ornaments and Easter eggs. An object such as a convex ball can be transparent, translucent, and support a dye receiving layer to improve display of the image.

### BRIEF DESCRIPTION OF THE DRAWINGS

FIG. 1 is a schematic diagram of current ink jet printing systems;

FIG. 2 is a schematic diagram of a ball printer in accordance with the current invention;

FIG. 3 is a front sectional of apparatus adapted to write on a object;

FIG. 4 is a side sectional view of the apparatus of FIG. 3;

FIG. 5 is a top view showing portions of the apparatus of FIG. 1; and

FIG. 6 is a schematic view of an apparatus for scanning an image on a sheet and for printing such image on an object.

### DETAILED DESCRIPTION OF THE INVENTION

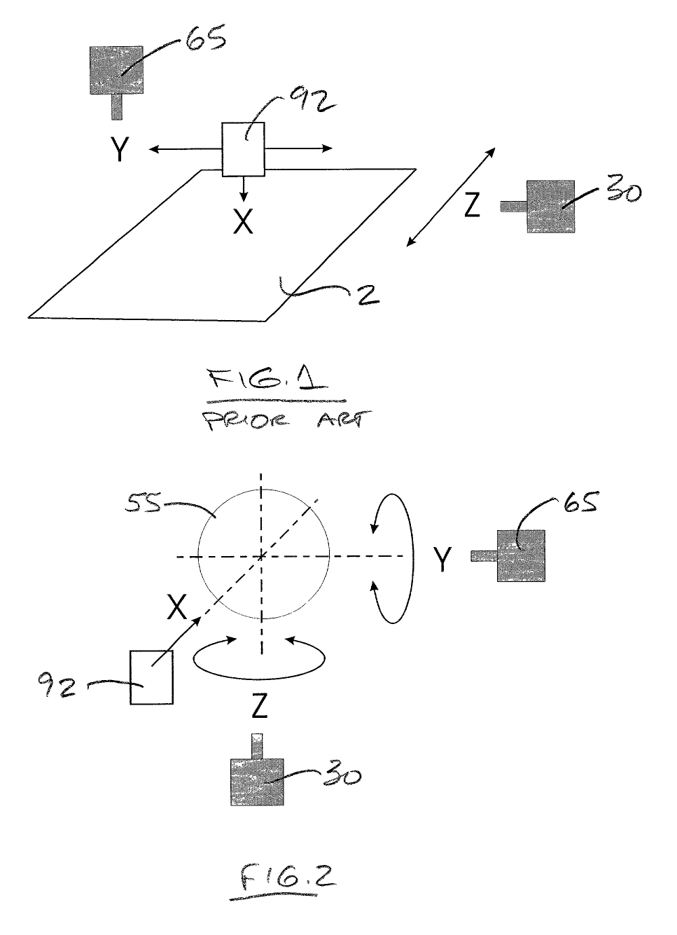

FIG. 1 is a schematic diagram of current ink jet printing systems. A sheet 2 is sequentially advanced by a Z-axis drive 30. After an incremental advance, an ink jet print head 92 is translated by Y-axis drive 65 to write part of an image onto sheet 2. Sheet 2 is sequentially advanced for each pass of ink jet print head until a complete image is formed on sheet 2.

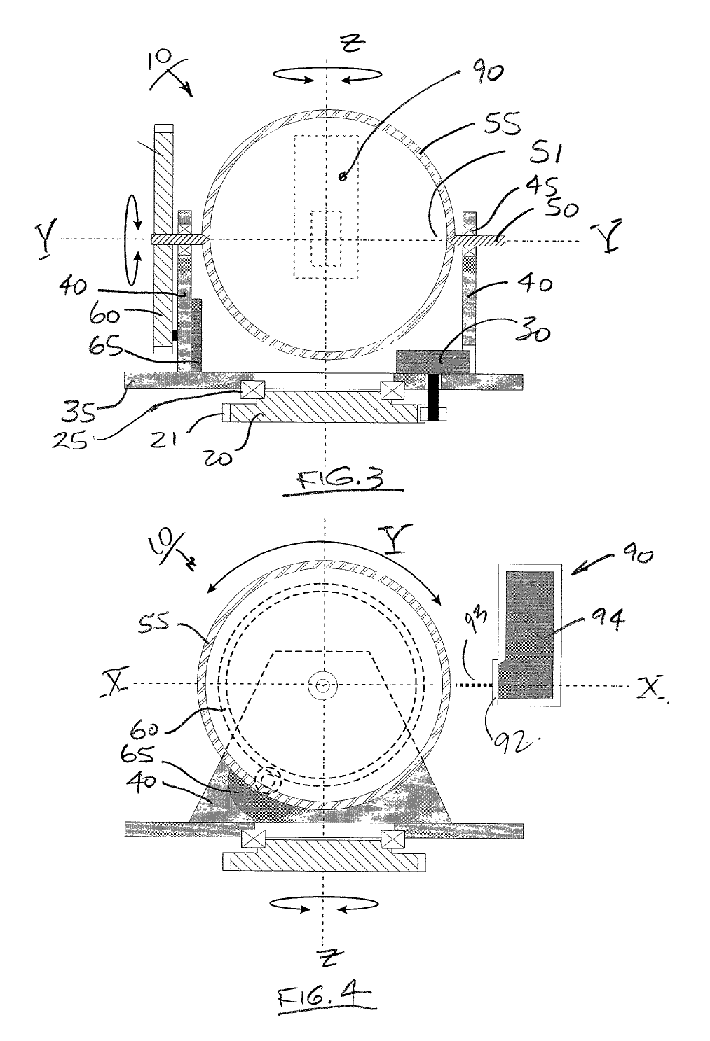

FIG. 2 is a schematic diagram of a ball printer in accordance with the current invention. Inkjet print head 92 is fixed in space, and Z-axis drive 30 and Y-axis drive 65 are oriented so that an object 55 rotated around either Y and Z maintains the intersection of both axes with the center of a convex surface on object 55. The ink jet print head 92 has a supply of ink and is located in a printing position relative to the object 55. The ink jet print head 92 ejects ink along a first axis which intersects the center of the convex surface at the printing position. Inkjet print head 92 is oriented so that the axis of ink ejection, X, intersects the center of a convex surface on object 55 independent of any rotation of object 55 about the Y and Z axes. Maintaining the intersection with the center of the convex surface on object 55 permits the use of two rotating drives and a fixed ink jet print head 92 to print objects onto a convex surface on object 55.

FIG. 3 is a front sectional of apparatus adapted to write on an object 55 having a convex surface. Such an object 55 can be a sport ball such as a golf ball, softball, or baseball and which is supported in apparatus 10. Alternatively, object 55 could be a Christmas tree ornament or Easter egg. Object 55 can be a sphere, nearly convex object or an object having a convex surface. Object 55 can be hollow to reduce inertial mass. Object 55 can be made of transparent or translucent material such as plastic or glass. The use of transparent or translucent materials permits the use of a light source within object 55. Object 55 can also have a coating of dye receiving material, such as gelatin or a reactive material that improves the adhesion of dyes to the surface of object 55.

Object 55 is held by apparatus 10. Apparatus 10 has a base 20 includes base gear 21 which is used to provide a first degree of rotation, Z, of object 55. The apparatus is designed so that the Z-axis of rotation passes through the center of a convex surface on object 55. Base bearing 25 can be a ball bearing of conventional design and permits rotation of object 55 around axis Z. Plate 35 supports the remainder of the mechanism of apparatus 10. Z-axis drive 30 is a stepper motor of conventional design, which is fixed to plate 35, and operates on base gear 21 to selectively rotate object 55 around axis Z.

Support arms 40 are attached to plate 35, and provide support for a second degree of rotation of object 55 around an axis, Y. Support arms 40 each have a support bearing 45 that permit a holding pin 50 to rotate about axis Y. Holding pins 50 engage object 55 so that the Y-axis of rotation intersects the center of a convex surface on object 55. Holding pins 50 create a Y-axis that is perpendicular to the Z-axis. The arrangement positions object 55 so that each axes maintains alignment with the center the convex surface on object 55 as object 55 rotates about the other axis. Holding pins 50 can hold object 55 with elastomer pads, or engage holding detail 51 detail in object 55.

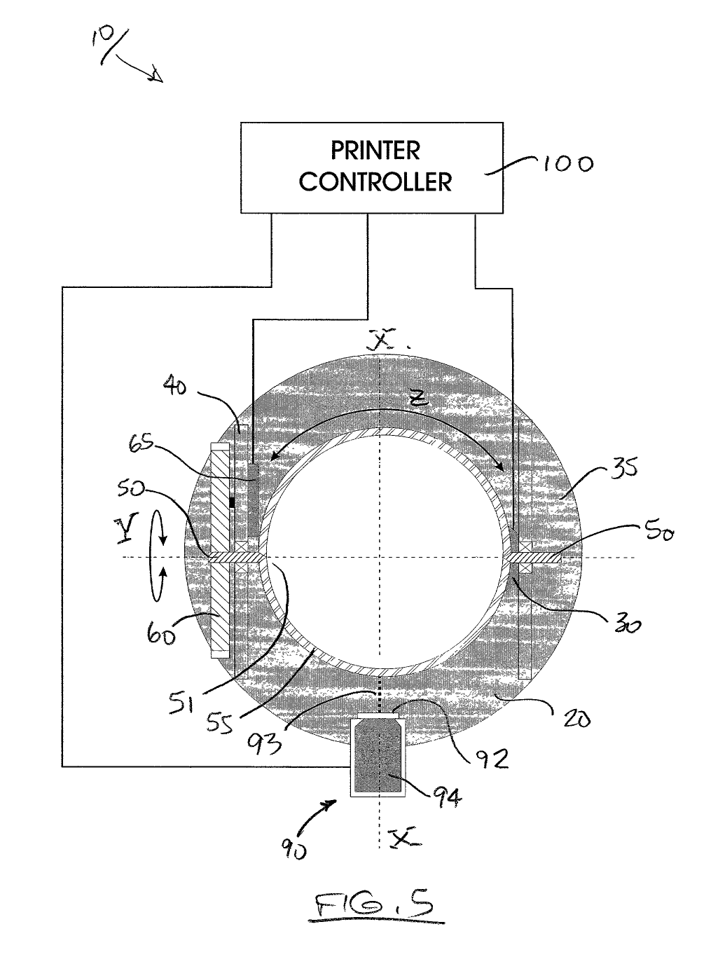

One of the two holding pins 50 passes through a support arm 40 and supports Y-axis gear 60. Y-axis drive 65 is attached to support arm 40 and operates on Y-axis gear 60 to rotate object 55 around axis Y. FIG. 4 is a side sectional view of the apparatus of FIG. 3, and shows the operation of Y-axis drive 65 on Y-axis gear 60. In the disclosed embodiment, the design of Y-axis drive 65 and Y-axis gear 60 permit a 360 degree rotation of object 55 around the Y axis. Rotating object 55 around 360 degrees of rotation permits a 360-panorama view, such as an Apple-VR image to be printed on object 55. Such a scene could be members of a team or a family in a 360 degree view printed around object 55.

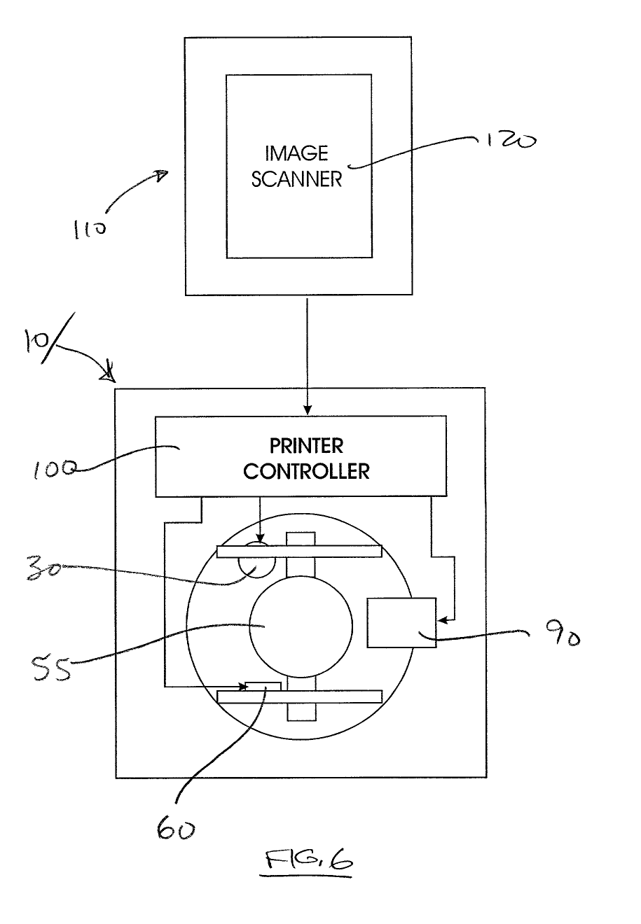

FIG. 5 is a top sectional view of apparatus 10. A mechanical frame (not shown) rigidly supports a print cartridge 90 with respect to base 20. Print cartridge 90 is of conventional design and has an ink jet print head 92 and an ink supply 94. Inkjet print head 92 can be a conventional piezoelectric head or a thermal head. Ink supply 94 alone can be removable and can have multiple reservoirs for colored printing. Alternatively, print cartridge 90 can be an integral unit that permits replacement of both ink jet print head 92 and ink supply 94.

The ink jet print head 92 includes a set of nozzles stacked in the Z direction. The set of nozzles selectively ejects droplets of ink 93 in strait lines. The nozzles are fired to eject ink onto a dye receiving surface which is translated lateral to the axis of the ink jet nozzles, a direction corresponding to rotation about the Z axis in the current apparatus. The dye receiving surface passes laterally, and the nozzles are fired to create a subimage. The substrate is then translated along the nozzle axis at a pitch equivalent to the height of the nozzles. The translation for the printing of each subimage is provided by the rotation of object 55 about the Y axis.

The central nozzle on the ink jet print head 92 defines a third axis, X. Print cartridge 90 is held so that this defined X axis intersects the center of the convex surface on object 55. Apparatus 10 has a configuration with all three axes intersecting the center of the convex surface on object 55 and provides a constant distance from ink jet print head 92 to dye receiving surface during a printing process.

For printing, object 55 is loaded into apparatus 10 and holding pins 50 engage object 55 so that the three axes intersect the center of a convex surface of object 55. Printer controller 100 receives digital data corresponding to an image. Printer controller then translates image data into drive signals for to Y-axis drive 65, Z-axis drive 30, and ink jet print head 92. Printer controller 100 can adjust the printing of each subimage to correct for convex aberrations induced by a linear print head and by the ends of each subimage.

Printer controller 100 spins object 55 around the Z-axis using Z-axis drive 30 for each subimage. As object 55 rotates about the Z axis, drive signals from controller 100 controls ink emission from ink jet print head 92. After a first subimage is printed, Y-axis drive 65 is activated to rotate object 55 in response to drive signal from controller 100 so that a subsequent blank area is moved under ink jet print head 92. Sequential strips of the digital image are deposited on object 55 until a complete image is written. The arrangement apparatus 10 is such that a complete 360 degree panorama view can be written on object 55. Because no rollers contact the printed surface, apparatus 10 eliminates the need for the feed rollers that exist on other ink jet printers. Object 55 can remain in apparatus 10 until the deposited ink is dry. Object 55 is removed from apparatus 10 after the deposited ink has dried. Holding detail 51 can be an opening in the object 55 that permits the introduction of a light source into object 55. Object 55 can be hollow and either transparent or translucent to permit transmission of light from an internal source. Light from inside object 55 can create illuminated 360 degree images on the surface of object 55.

FIG. 7 is a schematic view of apparatus 10 operating with scanner 15 to transfer images from flat image 120, such as a photographic print, onto object 55. A photographic print is positioned on scanner 110, and image data from scanner 110 is transmitted to controller 100 in apparatus 10. Apparatus 10 operates on the digital data from scanner 110 and prints the image onto the surface of object 55. Such a system can be in a kiosk that permits printing on objects. Controller 100 can also be adapted to take digital files from digital storage media or digital capture devices, including apparatus containing 360 degree field of views such as Apple Quicktime VR files incorporating 360 degree fields of view.

The invention has been described in detail with particular reference to a certain preferred embodiment thereof but it will be understood that variations and modifications can be effected within the spirit and scope of the invention.

### Parts List

2 sheet

10 apparatus

20 base

21 base gear

25 base bearing

30 Z-axis drive

35 plate

40 support arms

45 support bearings

50 holding pins

51 holding detail

55 object

60 Y-axis gear

65 Y-axis drive

90 print cartridge

92 ink jet print head

93 ink droplets

94 ink supply

100 printer controller

110 scanner

120 flat image

What is claimed is:

1. Apparatus for printing images on a convex surface of an object, comprising:
a) an ink jet print head having a supply of ink and located in a printing position relative to the object, the ink jet print head including means for ejecting ink along a first axis which intersects the center of the convex surface at the printing position;
b) means for holding the object;
c) means coupled to holding means for rotating the object about a second and third axes which intersect at the center the convex surface during printing; and
d) means for controlling rotation of the coupling means and the ink jet print head to cause the ink jet print head to eject ink along the first axis onto different positions of the convex surface to form an image on the object.

2. The apparatus according to claim 1 wherein the convex surface is spherical.

3. The apparatus according to claim 1 wherein the object is hollow.

4. The apparatus according to claim 1 wherein the three-dimensional object is transparent.

5. The apparatus according to claim 1 wherein the object contains detail and the holding means includes means for engaging the details to secure the object.

6. The apparatus of claim 1 wherein the coupling means rotates the object so as to cause the production of an image having a 360 degree field of view.

7. Apparatus for printing two dimensional images from a sheet onto a convex surface of an object, comprising:
a) a scanner for scanning two dimensional images on the sheet to produce a digital image;
b) an ink jet print head having a supply of ink and located in a printing position relative to the object, the ink jet print head including means for ejecting ink along a first axis which intersects the center of the convex surface at the printing position;
c) means for holding the object;
d) means coupled to holding means for rotating the object about a second and third axes which intersect at the center the convex surface during printing; and
e) means responsive to the digital image for controlling rotation of the coupling means and the ink jet print head to cause the ink jet print head to eject ink along the first axis onto different positions of the convex surface to form an image on the object.
